(19) United States
(12) Patent Application Publication
(10) Pub. No.: US 2002/0099596 A1
(43) Pub. Date: Jul. 25, 2002

(54) Dynamic ratemaking for insurance

(76) Inventor: Michael Kevin Geraghty, Marietta, GA (US)

Correspondence Address: LONG ALDRIDGE & NORMAN LLP, Suite 600, 701 Pennsylvania Avenue, N.W., Washington, DC, 20004, US

(21) Appl. No.: 09/992,408

(22) Filed: Nov. 26, 2001

Related U.S. Application Data
(60) Provisional application No. 60/253,108, filed on Nov. 27, 2000.

(51) Int. Cl. G06F 17/60

(52) U.S. Cl. 705/10

(57) ABSTRACT

A method of dynamically setting pricing rates for an insurance product includes observing the demand behavior of customers and assigning the customer to a pricing tier based at least in part on the observed demand behavior of the customer as compared to historical demand behavior of customers in a same market segment. Empirical data or statistical data of customer demand behavior is analyzed to adjust pricing tiers and market segments.

This application claims the benefit of U.S. Provisional Patent Application No. 60/253,108, filed on Nov. 27, 2000, which is hereby incorporated by reference for all purposes as if fully set forth herein.

### BACKGROUND OF THE INVENTION

1. Field of the Invention

The present invention relates to dynamic ratemaking for property and casualty insurance generally and particularly to processes and systems for generating rates for property and casualty insurance policies offered for sale to individuals.

2. Description of Related Art

Traditional pricing techniques for property and casualty insurance set rates that cover the variable cost associated with an individual policy and provide margin for fixed costs and reasonable profit. These policies are typically embodied in contracts or other agreements that require the insurance firm to provide services and assume risk for their customers.

There are two primary methods of determining rates for an insurance policy: pure premium method and loss ratio method.

The pure premium method calculates rates based on the following formula:

R=(P+F)/(1−V−Q)

P is pure premium and is based on experience losses which are used to project ultimate losses for the experience period. Pure premium is the ratio of experience losses to exposures in the same period. i.e.,

P=L/E

where

L is experience losses

E experience period earned exposures

The other components of the calculation are as follows.

R is the indicated rate per unit exposure

F is the fixed expense per exposure

V is the variable expense factor, i.e. expenses related to premium

Q is the profit and contingency factor

So the pure premium method computes rate as losses per exposure and fixed costs that are adjusted for variable costs, profit and contingency.

The loss ratio method develops indicated rate adjustments to existing rates as follows:

R=A R₀

where

R is the indicated rate

R₀ is the current rate

A is the adjustment factor

The adjustment factor A is computed as

A=W/T

Where T is the target loss ratio. The target loss ratio T is the ratio of one less the premium related factors to one plus fixed costs. The target loss ratio T represents the percentage of the rate to be used to cover future losses. T is calculated by considering all other components of the rate.

T=(1−V−Q)/(1+G) or T %=(100%−V %−Q %)/(100%+G %)

where V is the variable expense factor, Q is the profit and contingency factor, and G is the ratio of non-premium related expenses to losses.

For example, to determine premium related costs, profits and contingencies account for 10% of the rate (i.e. V+Q=10%) and fixed costs account for 20% of losses, then a loss ratio of 75% is effectively targeted. Calculating T as percentage:

T=(100−10)/(100+20)

90/120=75%

Thus a rate of $100 would be made up of

$75 for loss costs

$10 for variable costs, profit and contingency

$15 for fixed costs

where

G is the ratio of non-premium related expenses to losses.

In this example G has value $15 which is 20% of the $75 in losses. The other component of the adjustment factor W is the experience loss ratio

W=L/E R₀

As described above, L is experience loss; E is experience period earned exposures, and R₀ is the current rate. W represents the dollar amount of losses per dollar earned from exposures at the current rate Ro. For example, if the experience period consisted of 1000 earned exposures with a rate of $100 per exposure, $100,000 in premium was generated. If these exposures resulted in $90,000 in losses then the experience loss ratio W=90%. Based on this history, in order to change rates so that losses represent 75% of the rate instead of 90%, the current rate is adjusted by:

$$\begin{matrix}A = 90 / 75 \\ = 120 \%\end{matrix}$$

Both the pure premium and loss ratio methods generate the same rates when the same data and assumptions are made. Some straightforward algebra eliminates the intermediate calculations and gives the loss ratio premium as:

R=L(1+G)/E(1−V−Q)

So the loss ratio method generates rates by dividing losses adjusted for fixed costs by exposures adjusted for variable costs, profit margin and contingency. Since

L=EP by the definition of pure premium P, and

G=EF/L the fixed costs as a percentage of losses, therefore

G=F/P

Then, by substituting for L and G in the loss ratio equation, the pure premium equation becomes:

R=(P+F)/(1−V−Q)

Although these methods are mathematically equivalent they have significant practical differences. The pure premium method is based on exposures and so can be used for new lines of business where rates do not already exist. Pure premium requires a clearly defined unit of exposure, whereas the loss ratio method only requires aggregate rate and loss information.

With the exception of the profit component Q, all of the inputs to these traditional pricing variables are determined by historic, existing, or expected costs. Insurance companies derive profit in two ways: banking profit and underwriting profit. Since insurance premiums are paid in advance of the loss costs they incur, there is an opportunity for the insurance company to generate income through investment. This is called banking profit. Traditionally, ratemaking did not consider banking profit. Underwriting profit is the amount of money derived from premium in excess of the costs of running an insurance company. A 5% underwriting profit margin has become a standard component of the ratemaking process. An allowance for contingency is generally combined with the underwriting profit margin to arrive at a final rate. Recent regulatory and judicial decisions have caused insurance companies to revise the traditional exclusion of banking profit. Most notably, in 1969, the New Jersey Supreme Court ruled that investment income could not be ignored and in 1975 Massachusetts regulators required inclusion of investment income in ratemaking. This has led to use of CAPM (Capital Asset Pricing Model), the Total Rate of Return model, and discounted cash flow analysis for insurance ratemaking. The use of financial models for insurance ratemaking has presented a number of difficulties. These models are essentially explanatory, and accurate parameterization can only take place for historic data. Therefore, they are poor predictors of adequate and competitive rates. Additionally, the underlying assumptions of these models are more suitable to a wholesale and relatively frictionless market for financial instruments. They fail to reflect key features of the retail environment for property and casualty insurance.

Development of models that are sensitive to investment income has not addressed the issue that competitive or demand level information is still not considered. There is a need for an insurance ratemaking process that accounts for competitive position, intangibles such as consumer brand preference, and consumer price sensitivity. Dynamic ratemaking incorporates the traditional insurance ratemaking methodologies, as well as techniques that analyze competitive position and consumer behavior, to arrive at rates that optimize profitability.

Dynamic pricing has had significant success in recent years in the Pricing and Revenue Management programs launched by travel and transportation companies. These tend to be high fixed cost/low variable cost industries with capacity limitations and advanced knowledge of consumption through a reservation process. Most of the specific dynamic pricing techniques used by travel and transportation companies are not applicable to insurance ratemaking because they are designed to price perishable inventory and assume constrained capacity. Insurance, by contrast, has a high variable cost/low fixed cost structure, which means that rate moves have a greater impact on profitability. This is because higher volumes erode the fixed cost per unit sale burden but not the variable cost.

Insurance inventory is generally not perishable. Capacity may be limited by considerations such as available capital or exposure, but it does not have detailed tactical constraints analogous to a limited number of rooms in a hotel for a given night. The insurance industry also has variable costs that are specific to an individual customer. Therefore, the insurance industry already practices differential pricing. Dynamic ratemaking exploits customer behavior information to make these rate differentials conform to customer price sensitivity.

The dynamic ratemaking process of the present invention includes three major components: customer contact, rate analytics, and rate management.

### SUMMARY OF THE INVENTION

Accordingly, the present invention is directed to dynamic ratemaking of property and casualty insurance that substantially obviates one or more of the problems due to limitations and disadvantages of the related art.

An object of the present invention is to provide a process for implementing dynamic ratemaking business practice, a methodology for computing dynamic rates and an automated dynamic ratemaking system for implementing the methodology.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of dynamically determining pricing rate for a product includes the steps of grouping demand for any of a plurality of products together into any of a plurality of market segments based on a group of pricing variables; analyzing demand behavior of each market segment for consumer price sensitivity and competitive position; assigning each analyzed market segment to a pricing tier; generating forecasts of demand for each analyzed market segment; and optimizing a pricing rate of a specific product based on said generated forecasts of demand. The rate optimization process continues by repeating these steps and adjusting rates in a price tier assignment table based on observed demand.

In another aspect of the present invention, a method of determining an optimized price for offering a product to a customer includes the steps of analyzing attributes of a customer's demand behavior; assigning the customer to one of a plurality of price tiers based upon the attributes of the customer's demand behavior; forecasting a price at which the customer will accept an offer to purchase the product based on the assigned price tier; and generating an optimized price based on the assigned price tier. The method further includes compiling the attributes of a plurality of customers; and adjusting rates associated with the plurality of price tiers based on the compiled attributes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates an example of how corporate profitability is sensitive to the consumers response to price and competitive position;

FIG. 2 illustrates an example of the value of segmentation;

FIG. 3 illustrates an example of the major components of the dynamic ratemaking system.

FIG. 4 illustrates a process flow of a rate analytics process;

FIG. 5 illustrates an example of acceptance probability that a customer will purchase an insurance policy at a given base rate;

FIG. 6 illustrates a method to determine optimal profitability;

FIG. 7 illustrates assignment of market segments to price tiers;

FIG. 8 illustrates rate adjustment in price tiers; and

FIG. 9 illustrates a graphical user interface of the decision support system which presents rate recommendations.

### DETAILED DESCRIPTION OF THE ILLUSTRATED EMBODIMENTS

Reference will now be made in detail to embodiments of the present invention, example of which is illustrated in the accompanying drawings.

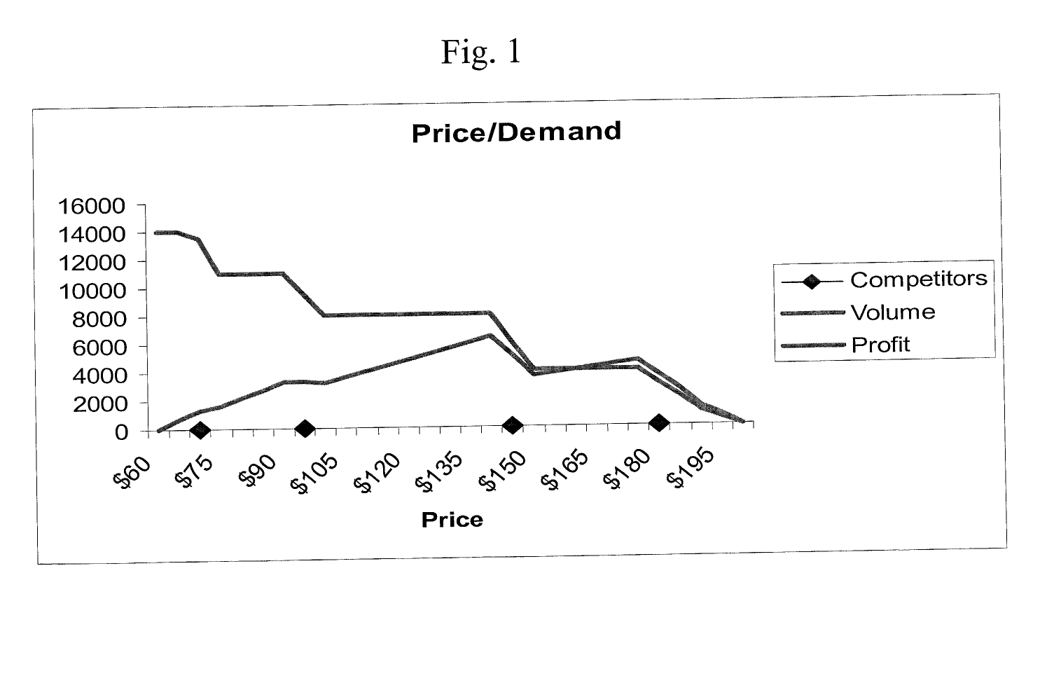

Dynamic ratemaking refers to a seller's ability to adjust rate in response to market demand and customers price sensitivity. Optimal dynamic ratemaking trades off a customers likelihood to purchase a policy with the revenue value of the policy to find the maximum expected benefit to the seller in terms of revenue generation and other business objectives. In contrast to current insurance industry practice, rates generated by dynamic ratemaking incorporate information derived from consumer demand and consumption behavior. Rates are adjusted based on what consumer behavior reveals about price sensitivity. FIG. 1 illustrates how corporate profitability is sensitive to the consumers response to price and competitive position. As can be seen in FIG. 1, both profit and volume vary as price increases.

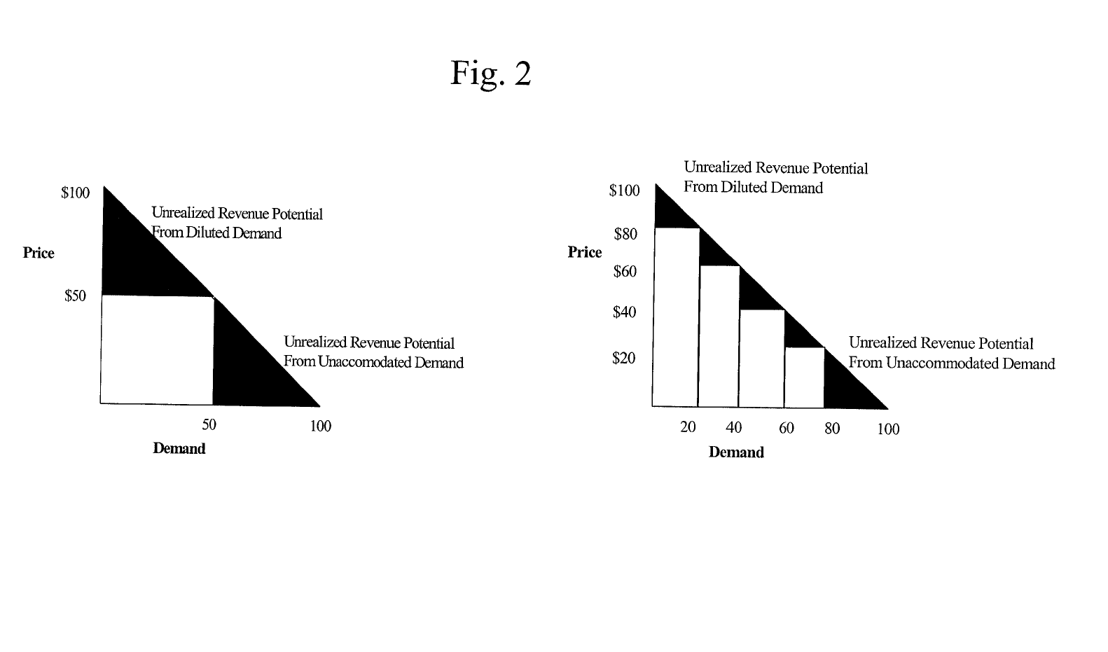

Dynamic ratemaking produces value through segmentation. The insurance industry is unique in the degree to which its unit costs are sensitive to customer segments. This has created a pricing environment that is focused on cost-based pricing and detailed segmentation by customer characteristics. In contrast, dynamic pricing splits demand into segments that may or may not reflect individual customer characteristics. Dynamic pricing also produces value by extracting a signal about competitive position from customer behavior or from explicit comparison shopping. It relies on rich data capture and quick response to support very precise and timely pricing decisions. In the illustrated example in FIG. 2 a single price generates $2,500 whereas a collection of differently priced segments generate $4,000 in revenue in the same price/demand environment.

The principles of dynamic ratemaking can be applied in a variety of ways. The key change to the insurance industry business process is to make more targeted rate adjustments in shorter timeframes than current practice. This can be achieved through operational rate management or alternatively through automated rate management. Both rely on frequent and consistent application of statistically sound pricing decisions.

Operational rate management environments implement tactically focused decision support systems that monitor customer behavior and produce rate recommendations for product managers to review, edit, approve or reject. Automated pricing uses computer programs to update rates without human intervention. Analysts set parameters and decision rules that influence the systems performance, but rarely control individual pricing decisions.

Automated rate management combines computer and communications technology with control systems design and the economics of rate to offer customers a rate that maximizes the expected economic benefit to the seller. Automated rate management tends to be effective in pricing environments with high transaction volumes. The current invention is useful in either an operational rate management or an automated rate management implementation.

A key challenge for implementation of dynamic ratemaking principles in the insurance industry is the complex regulatory environment. A state by state discussion of regulatory issues is not attempted as part of this disclosure. Instead, a general approach to implementing dynamic pricing under various types of regulatory environments is described.

Dynamic ratemaking is sometimes associated with poor customer service, particularly in the mind of the customer. An increasingly complex pricing structure can create the perception of unfair treatment. In fact dynamic ratemaking tends to enhance the customer experience by targeting rate-sensitive customers with lower rates and higher valued customers with policy attributes that they value.

Definitions

The following terms are assumed to have the specific technical meaning defined here when used in the detailed description of the invention:

Acceptance occurs when a customer enters into an insurance contract in response to an offer from the insurance company. A customer that accepts an offer of insurance is said to have converted.

Active Pricing Variable is one that is currently in use. It is a pricing variable for which demand information is tracked by the rate analytics system and rate change recommendations are generated.

Adverse selection occurs when a grouping of customers into a rating category, such as an underwriting tier, attracts customers that lower the value of the group to the insurance company. For example, an underwriting tier has a single base rate that applies to customers with a range of individual expected loss costs. The customers with lower risk may find a better rate with competitors that use a different range of expected loss costs. Therefore the tier will disproportionately attract higher risk customer than originally anticipated, thereby lowering the profitability of the tier.

An Application is a request for insurance accompanied by the information that the insurance company has requested from the customer, so that the insurance company can compute a rate.

A Base Rate is a dollar amount associated with an underwriting tier and coverage type that provides the basis for computing a specific rate for a customer. The base rate is the amount that a risk should be charged if all their relativity factors equal 1.0. Thus, a base rate is a generic dollar amount for an underwriting tier and coverage type that reflects an absence of specific information about the customer.

Consumption occurs when a customer enters into an insurance contract in response to an offer from the insurance company. This term is used interchangeably with acceptance.

Conversion Rate is the percentage of customers that accepted an offer of insurance with respect to the number of request for insurance.

Coverage Type is a defined type of risk that the insurance company agrees to indemnify in an insurance contract. For example, an insurance policy that agrees to indemnify injuries caused to third parties by a driver of an automobile is referred to as a Bodily Injury policy. Bodily Injury is an example of a coverage type.

A Customer is an individual or group of individuals, such as a family, that have requested an offer of insurance, or potentially will request an offer of insurance.

Demand is a measure of the attractiveness of an insurance product. Information about demand is determined from customer behavior such as sales pace and conversion rate.

A Demand Surrogate is an observable measure of the attractiveness of an insurance product. Sales pace and conversion rate are used as demand surrogates because they give a good indication of product attractiveness, but do no capture all demand information. For example, customers that did not follow through the application process because they did not have information readily to hand, but would have purchased had they completed the application, are not reflected in the sales pace or conversion rate.

Insurance is a legal contract whereby an insurance company indemnifies a customer from certain risks in return for a premium.

Market Segment is a collection of customers that share a similar value for a pricing variable. The pricing variable is used to group customers into market segments that have similar demand behavior and price sensitivity.

An Offer is a description of a potential insurance policy combined with a rate for the policy presented by the insurance company to a customer for acceptance. Planning Horizon is the number of days in the future for which rates are managed, for example 90 days.

Policy is a contract of insurance between an insurance company and a customer.

Premium is the amount paid by the customer for insurance coverage.

A Pricing Analyst is the primary business user of this invention. This is a person in the insurance company that is responsible for price levels.

A Pricing Tier is an underwriting sub-tier selected for an application based on underwriting variables, prior to rating a policy. In traditional insurance pricing, once an underwriting tier is selected, the base rates to use in the rating algorithm are also known. In dynamic pricing, an additional tier selection step is required before the base rates are known. Each underwriting tier is divided into multiple pricing tiers. An application is assigned to a pricing tier based on the market segment the applicant belongs to. The assignment of market segments to pricing tiers is stored in a pricing tier assignment table. Each pricing tier corresponds to a base rate adjustment that is applied against the base rates selected for the applicant associated with the applicant's underwriting tier.

A Pricing Tier Assignment Table contains the assignment of market segments to pricing tiers.

A Pricing Variable is an attribute of the application for insurance or an attribute that can vary in value from one request for insurance to another. The age of the customer is an example of an attribute that typically is provided on the application. Originating web-site is an attribute that is not typically part of an application but can vary from one request to another, when the requests are conveyed to the insurance company through the Internet.

An Observation is data that is captured from a customer contact point and saved in a form that makes it amenable to the rate analytics process.

Rate is the amount asked by the insurance company from the customer in return for issuing a policy.

A Rate Guarantee is a period of time during which the rate offered to a customer is guaranteed, such as seven days. If the customer accepts the offer at any time during that period, the original rate will be honored even if the rates have changed.

A Rating Variable is an attribute of an application for insurance that may have different values on different applications and that will cause the rate offered by the insurance company to change based on its value. Examples of rating variables include vehicle make, model, year of manufacture, modifications, use (e.g., personal, business, artisan), Insured age, occupation, homeownership, address, financial responsibility, mileage, prior insurance named drivers, points on license, deductible.

Rejection occurs when a customer decides not to enter into an insurance contract in response to an offer from the insurance company. Rejection is detected by a statement of refusal by the customer or expiry of the rate guarantee.

A Relativity is a factor that is applied to the base rate for a coverage to generate a rate that is specific to an individual applicant. The value of the factor is dependent on the value of the rating variable it is associated with.

Risk is an industry term for customer.

Sales Pace is the number of new insurance policies issued by an insurance company within a given time interval.

Underwriting is the process of allocating an underwriting tier to an application based on risk factors.

An Underwriting Tier is the grouping of applicants based on their risk characteristics prior to rating. Each underwriting tier is associated with a set of base rates, one for each coverage type. Relativities are applied to the base rates to generate a rate for the particular applicant.

An Underwriting Variable is an attribute of an application for insurance that may have different values on different applications and that will cause the underwriting tier selected by the insurance company for this application to change based on its value.

Implementation of dynamic ratemaking is dependent on the nature of customer contact and interaction. In the traditional model, insurance transactions take place between an agent of the insurance company or an independent broker and the customer. Typically, the insurance firm disseminates information about rates to the agent by means of a rate sheet or rating manual. While the agent generally captures consumption information and returns it to the insurance firm there is very little capture of information about unsatisfied demand and price sensitivity.

The direct sales approach offers an alternative mode of interaction. In this case, insurance transactions are managed through the mail or through telephone call centers. The key difference between direct sales and agency as far as dynamic ratemaking is concerned, is that the representative of the insurance firm is generally present at a central location and therefore has greater access to frequent rate updates. Direct sales supports better data capture of information about unsatisfied demand and price sensitivity.

Recent improvements in communications technology has enhanced the viability of frequent rate adjustments in both modes of customer contact. Electronically distributed rates can provide agents with daily or even real-time updates of rate adjustments. Call center software can track demand activity and create improved capture of the customer behavior information required by dynamic ratemaking. The emergence of e-Commerce on the world wide web creates a new mode of direct sales. Customers interact directly with an automated system such as a web-site that offers insurance policies for sale. When this system incorporates relevant components of the dynamic ratemaking invention, it has the capability to provide comprehensive data capture of customer behavior information and utilize that information to implement frequent rate adjustments. Among other methods, this invention encompasses systems for capturing information within the three modes of customer interaction: agency, traditional direct sales, and web-based direct sales. An alternate, although less desirable, mode of customer interaction used to capture information includes surveying the customer in a non-sales environment.

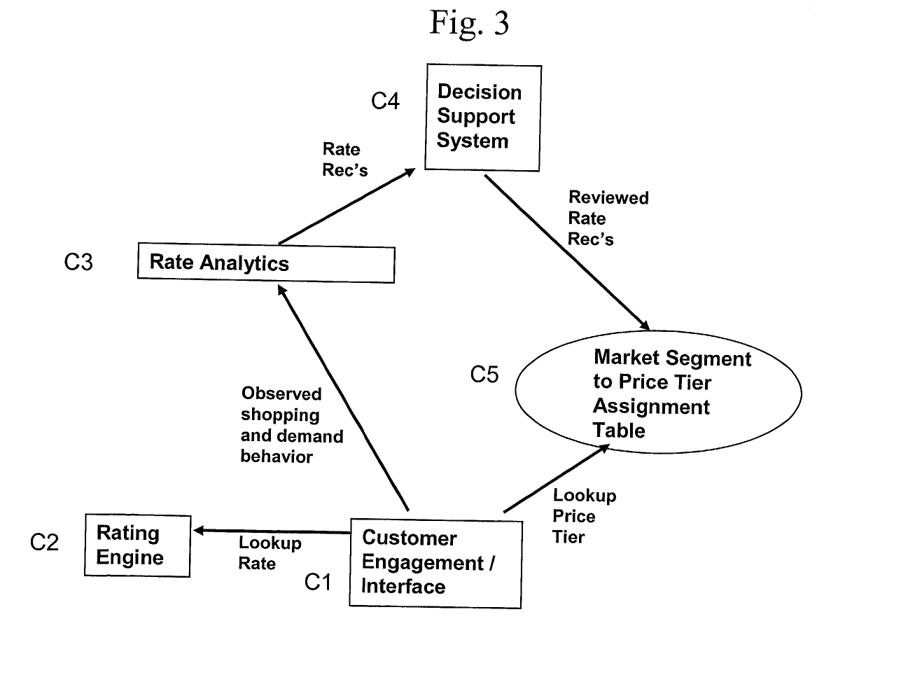

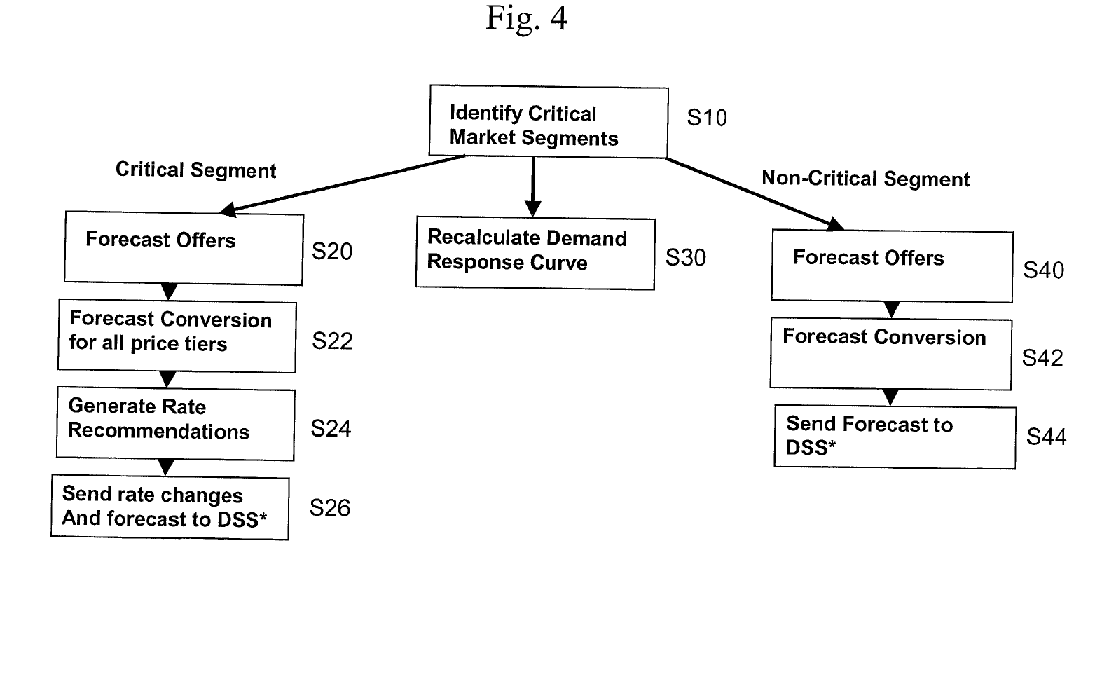

The computer system required to support the customer contact business process has two major objectives. It must deliver the frequent rate updates generated by the rate analytics and rate management systems and it must capture customer behavior data for pricing analysis. FIG. 3 illustrates the major components of the system. FIG. 4 illustrates a process flow of a rate analytics process.

As shown in FIG. 3, when customer shopping behavior triggers a rate calculation a customer engagement interface (C1) identifies a customer's market segment and looks up the customer's price tier from a price tier assignment table (C5). The customer's price tier determines the customer's base rates, which are used by a rating engine (C2) to calculate the rate to offer the customer. At regular intervals, e.g. daily, data from all transactions for the most recent interval is provided to the rate analytic process (C3). The rate analytics process generates rate recommendations that are reviewed by pricing analysts through a decision support system (C4). The accepted or modified recommendations are implemented in the market segment to price tier assignment table (C5) by updating look-up tables and price tier assignment criteria.

The process of rate analytics combines information from traditional insurance ratemaking data sources, competitor monitoring, and customer behavior to develop recommended rate adjustments. In one embodiment of the present invention, data captured during sales to customers, or customer inquiries and other interactions, for example, is automatically transferred to and/or compiled by the rate analytics process. Other types of data, for example, market survey data, may also be provided to the rate analytics process to be used in the decisions support system.

There are two key concepts that are central to dynamic ratemaking systems implementation: market segments and pricing tiers.

Demand for insurance policies can be grouped together into market segments based on group characteristics referred to as pricing variables. Pricing variables may include rating variables, such as vehicle make, model, year of manufacture, use (personal, business, artisan), insured age, occupation, home ownership, address, financial responsibility, mileage, prior insurance, named drivers, points on license, deductible, etc. For example, a group of customers all in the same age range may be regarded as a market segment. In this case, age range is a pricing variable that is based on a customer characteristic. Pricing variables may represent customer characteristics, customer behavior, or policy attributes, for example. Such pricing variables representing other attributes may include, for example, days prior to expiration of an existing policy, originating website, impact on insurance company exposure, etc. The number of days prior to consumption is an example of a customer behavior based pricing variable. Customers that arrange for the purchase of insurance well in advance of the effective date of the policy may be defined to represent a different market segment to those that purchase at the last minute.

Pricing variables are used to group demand into market segments so that the demand behavior of each market segment can be analyzed for price sensitivity and intangible value to the consumer. Once this analysis is complete, each market segment may be assigned to a pricing tier. Rate analytics makes the assignment of market segment to pricing tier so as to maximize expected revenue generation and other business objectives, such as market share targets.

The rate analytics process consists of ad hoc analysis and regularly scheduled analytic processes. Ad hoc analysis involves development and application of data mining, statistical analysis and other techniques to the available information captured by the customer contact process. More effective general types of ad hoc analysis are described as an example along with the data that is required to support them.

Competitor monitoring is an important component of dynamic ratemaking. It is supported by a competitor monitoring system that extracts the best available information about competitor rate values and positions for use in both ad hoc and regularly scheduled analytic processes. This information is also delivered to the rate analytics process. Insurance regulators in most states of the United States require rating algorithms to be publicly available. This means explicit knowledge of competitor pricing algorithms is available for incorporation into the competitor monitoring system.

Traditional insurance pricing processes estimate the variable costs associated with the individual policy and the variable costs associated with serving the customer. These are combined with an allocation of the fixed cost associated with running the insurance company and an allocation for profit and contingency to get a rate. Dynamic ratemaking incorporates all these traditional inputs into the computation of rate.

The dynamic ratemaking analytic process (i.e. rate analytics) generates rate change recommendations based on changes in customer demand and consumption behavior. The input to this process is the most recent observations of sales pace and conversion rate for each active pricing variable. The output is the price tier assignment for each market segment that maximizes expected profit system-wide.

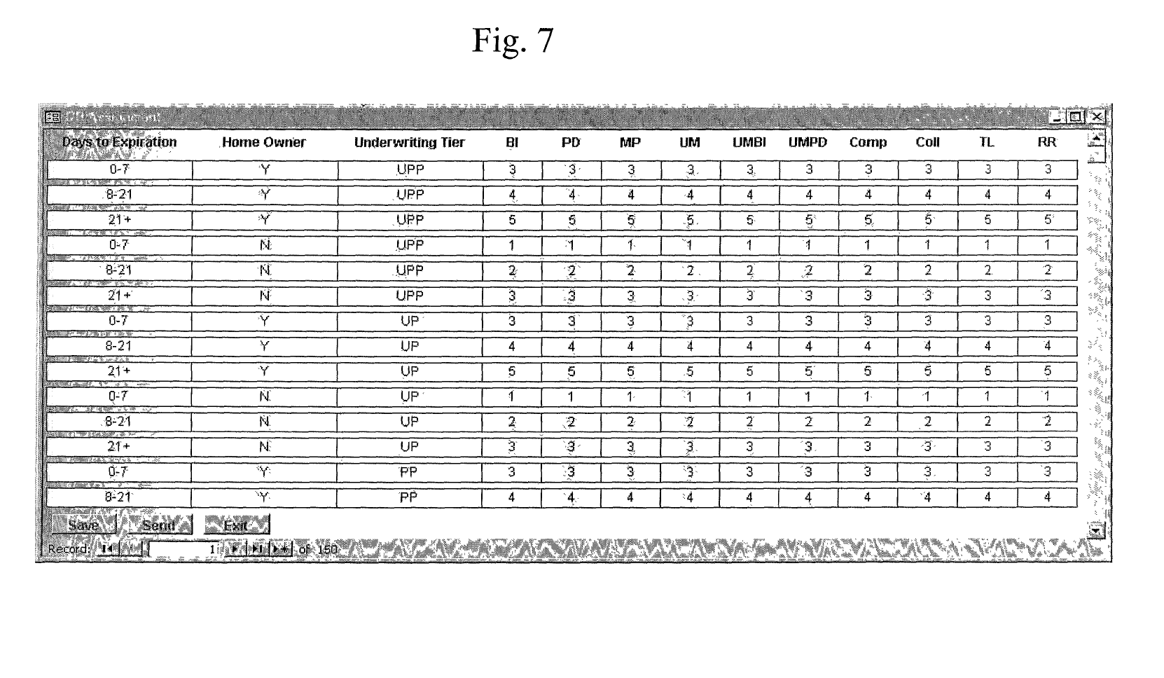

FIG. 7 illustrates an example of the assignment of market segments to price tiers. The market segments in this example of the assignment table are defined by the values of the following variables: Days to expiration, home ownership, underwriting tier, and coverage type. The integer values in the columns underneath the coverage types indicate the price tier associated with each market segment.

The rate analytics process can be broken into the following components: (1) Identify Critical Market Segments; (2) Forecast Demand; (3) Generate Rate Recommendations; (4) Recalculate Demand Response Curves. FIG. 4 illustrates the process flow of rate analytics.

As shown in FIG. 4, the components of the rate analytics process can be described as separate sub-process flows. After identifying the Critical Market Segments S10, forecasts are determined for Critical Segments and Non-Critical Segments. Forecasting for the Critical Segments is performed by forecasting offers S20, forecasting the conversion for all price tiers for the critical segments S22, generating rate recommendations for the Critical Segments S24, and sending rate changes and forecasts to the Decision Support System S26. Forecasting for the Non-Critical Segments is performed by forecasting the offers S40, forecasting the rate of conversion S42, and sending the forecasts to the Decision Support System. The Demand Response Curve is recalculated in response to user defined triggers such as a regular schedule or ad hoc timing in reponse to user requests or modification of parameters.

Each market segment has associated with it a forecast of demand for the previous run of the analytic process. If not, the analytic process will create one. This forecast is based on the historic demand observed for this market segment and is generated on a regular basis by the analytic process. A forecast of demand consists of a mean and higher moments, such as a standard deviation, associated with a demand surrogate such as conversion rate or demand pace. The forecast of demand is compared to the most recent observation of the actual demand level. This comparison uses standard statistical tests to evaluate if the most recent observation indicates that the demand level has changed since the forecast was computed. If a demand level is identified as sufficiently different from the forecast to be indicative of a demand change, it is placed on a critical segment list (S10). The rules for assigning markets to the critical segment list are defined by the pricing analyst. For example, an unlikely observation level as compared to market segment history could indicate a critical segment. An unlikely observation level is one that produces a value that lies outside a threshold probability level identified by the pricing analyst. This value is expressed as a percentage probability threshold. For example, a demand forecast for a market segment has the following values:

| | |
|---|---|
| Expected demand level | 50 |
| Standard deviation of demand | 10 |
| Probability Threshold | 95% |

By making the appropriate distributional assumptions, a range of values for the observation that fall within a 95% probability interval can be computed. If the observation falls outside this range the market segment is placed on the critical segment list.

A significant change in trend is another possible indicator. This is a change in trend that produces a value that lies outside maximum and minimum trend levels identified by the pricing analyst. These levels are computed as percentages of demand. Trend is computed by a Holt-Winters time-series model according to a formula in which:

t is a counter of time intervals

X[t] is the demand observed at time t

A is a constant term

B is the trend factor

e[t] is the error term

S[t] is the forecast of demand level calculated at time t

α is the smoothing constant for demand level

β is the smoothing constant for trend Then

S[t]=αx[t]+(1−α)(S[t−1]+B[t−1])

B[t]=β(S[t]−S[t−1])+(1β)B[t−1]

If the maximum trend is specified to be 20% per time period, and

B[t]>0.2*S[t]

Then, the market segment is assigned to the critical segment list. Other possible indicators include significant changes in demand variability or forecast error from market segment history; unlikely demand level based on other market segment performance; unlikely demand trend based on other market segment performance; and pricing analyst requested addition to the critical segment list. These are measured by standard statistical tests like those indicated above.

For each critical market a candidate tier assignment is proposed based on selection rules defined by the pricing analyst. For the simple case where the observed demand level is higher than expected, the candidate tier may be the next tier higher than the current tier for the market segment. For low demand the next tier lower than the current tier would be assigned as the candidate. A more complex rule may require market segments to be identified as critical for two or more concurrent scheduled runs of the rate analytic process before recommending a rate adjustment. This is achieved by defining a candidate tier selection rule that incorporates historical criticality. Once candidate tier assignments have been made for each critical market segment, forecasts of demand are generated for the current tier for both critical and non-critical market segments and the candidate tier for each critical market segment.

In an embodiment of the present invention, two demand forecasts are generated, a forecast of offers (S20, S40) and a forecast of conversion rate (S22, S42). The conversion rate forecast is applied to the offers forecast to generate an expected number of conversions.

Based on the most recent history of offer activity, a forecast of the number of offers for each rate segment is generated for the planning horizon. It is assumed that the number of requests for offer for each rate segment is independent of the rate. Therefore the offer forecast is generated by a time-series methodology that captures trend and seasonality and causal factors such as promotional activity. The rate management interface provides the pricing analyst with screens to influence the level of the offer forecast by setting parameters to compensate for market conditions that the forecasting models do not normally incorporate.

The customer will respond to offers of insurance on a web-site in three primary ways. The customer will accept the offer at once; the customer will accept the offer at a later point in time; or the customer will reject the offer. Because of this, an accurate picture of conversion rate is not available until a number of days past the offer date, equivalent to how long the offer remains good.

The conversion forecast will apply to recent offers still outstanding and offers expected to come in the planning horizon. The conversion rate forecast assumes the current rate tier assignments are not changed. If a recent change to tier assignment has been made, the target conversion rate is substituted for the conversion rate forecast.

The following table illustrates a forecasting methodology that capitalizes on knowledge of historic conversion rate behavior. Each row in the table represents a date on which offers of insurance are made. Today's date in this example is 01/08/00. The numbers across the top represent the number of days past the offer date that policies were written. The values in these columns are the number of policies that were written. So on 4 days after 1/2/00, which is 1/6/00, there were 4 policies written arising from offers made on 1/2/00. The total number (integers) of offers made on 1/2/00 was 78. The bold numbers represent actual observed values. Since it is 1/8/00 the number of polices that converted for 1/7/00 on that day is available, but no other information. For 1/4/00 real information for 1, 2, 3, and 4 days past is available, which takes us to 1/7/00. For 1/8/00 (today) results will not be available until the end of the day.

| | | | | | | | | | | Expected |
|---|---|---|---|---|---|---|---|---|---|---|
| Offer | | | | | | | | Total | Total | Conversion |
| Date | 6 | 5 | 4 | 3 | 2 | 1 | 0 | Offers | Policies | Rate |
| 1/1/00 | 3 | 4 | 2 | 4 | 6 | 1 | 1 | 97 | 21.00 | 22% |
| 1/2/00 | 2.41 | 3 | 4 | 2 | 3 | 2 | 4 | 78 | 20.41 | 26% |
| 1/3/00 | 3.22 | 4.14 | 3 | 0 | 4 | 3 | 3 | 104 | 20.36 | 20% |
| 1/4/00 | 2.69 | 3.47 | 2.92 | 4 | 1 | 0 | 2 | 87 | 16.08 | 18% |
| 1/5/00 | 2.07 | 2.67 | 2.25 | 1.89 | 2 | 1 | 0 | 67 | 11.88 | 18% |
| 1/6/00 | 3.37 | 4.34 | 3.66 | 3.08 | 3.93 | 2 | 0 | 109 | 20.38 | 19% |
| 1/7/00 | 3.06 | 3.95 | 3.32 | 2.79 | 3.57 | 1.62 | 1 | 99 | 19.31 | 20% |
| 1/8/00 | 2.83 | 3.65 | 3.08 | 2.58 | 3.30 | 1.50 | 1.62 | 91.57 | 18.55 | 20% |
| 1/9/00 | 2.83 | 3.65 | 3.08 | 2.58 | 3.30 | 1.50 | 1.62 | 91.57 | 18.55 | 20% |
| 1/10/00 | 2.83 | 3.65 | 3.08 | 2.58 | 3.30 | 1.50 | 1.62 | 91.57 | 18.55 | 20% |
| 1/11/00 | 2.83 | 3.65 | 3.08 | 2.58 | 3.30 | 1.50 | 1.62 | 91.57 | 18.55 | 20% |
| 1/12/00 | 2.83 | 3.65 | 3.08 | 2.58 | 3.30 | 1.50 | 1.62 | 91.57 | 18.55 | 20% |
| 1/13/00 | 2.83 | 3.65 | 3.08 | 2.58 | 3.30 | 1.50 | 1.62 | 91.57 | 18.55 | 20% |

The non-bold numbers (non-integer) with 2 decimal places shown are forecasts. They are derived as follows. For each offer date and days past pair, the number of policies is divided by the total number of offers for the offer date to get an observed conversion rate. The observed conversion rate is stored in another table, as shown below. An average of all conversion rates for each days past is calculated to get a typical conversion rate for each days past. The days past conversion rate is multiplied by the offers for each day in history to get an expected number of policies. For days in the future, the average total number of offers is used to forecast these days, and then the average days past conversion rate is used to complete the rest of the table. The sum of the numbers in each row gives the total number of policies expected to be written. Thus, the expected conversion rate for each offer day can be computed.

| Offer Date | 6 | 5 | 4 | 3 | 2 | 1 | 0 |
|---|---|---|---|---|---|---|---|
| 1/1/00 | 3% | 4% | 2% | 4% | 6% | 1% | 1% |
| 1/2/00 | | 4% | 5% | 3% | 4% | 3% | 5% |
| 1/3/00 | | | 3% | 0% | 4% | 3% | 3% |
| 1/4/00 | | | | 5% | 1% | 0% | 2% |
| 1/5/00 | | | | | 3% | 1% | 0% |
| 1/6/00 | | | | | | 2% | 0% |
| 1/7/00 | | | | | | | 1% |
| | 3% | 4% | 3% | 3% | 4% | 2% | 2% |

In practice the table will span sufficient history to get good forecasts and all future days in the planning horizon.

Since more recent data is more indicative of future events than older data, the averages computed by the forecasting algorithm are in fact weighted averages that put more emphasis on recent data. The calculation of the forecast in each column is based on observed variability in the data. Each new observation is incorporated into the forecasted conversion rate as follows.

New forecast=Gain*Observation+(1−Gain)*Old Forecast

The gain is computed as

Gain=Number of Offers/(Number of Offers+K Factor)

where K factor is the ratio of the process variance to the variance in the hypothetical mean. In the case of market segments that have had a recent change in their price tier assignment, the historic conversion rate is a poor indicator of future conversion activity. For the first forecast after the price tier assignment change the conversion rate is set equal to the target conversion rate described in the following paragraph. This is equivalent to a gain of unity. For subsequent forecasts, the gain is updated to account for observations that occur after the price tier assignment.

Each critical market segment gets an additional forecast that represents the conversion rate for the candidate price tier. This is referred to as the target conversion rate. It is derived by multiplying the conversion rate forecast for the current price tier by a shift factor. The shift factor is derived from the demand response curve for the market segment. The demand response curve is a collection of conversion rates, each associated with an individual price tier. These conversion rates are not used directly. The relative difference in the conversion rate between current and candidate tier is used to make the adjustment and compute the target conversion rate.

For example, the following table is generated during the demand response curve update process.

| Price | Logit P | Current | Relative |
|---|---|---|---|
| Tier | Value | Tier | Change |
| 1 | 22% | 2 | 92% |
| 2 | 24% | 2 | 100% |
| 3 | 26% | 2 | 108% |
| 4 | 28% | 2 | 117% |
| 5 | 30% | 2 | 125% |
| 6 | 32% | 2 | 133% |
| 7 | 34% | 2 | 142% |

If the conversion rate forecast for the market segment under review is 3% and the price tier assignment is changed from 2 to 1, a target conversion rate is determined by multiplying 3% by 92% to get a target conversion rate of 2.75%.

Rate Optimization compares the amount of profit that can be expected from the current pricing tier to the amount of profit expected from the candidate tier to decide if a rate change is warranted. Since a change in rate does not affect the number or type of offers that are requested the same offer forecast applies to each tier. This is multiplied by the expected conversion rate of the current tier to get the expected number of written policies in the planning horizon for the current tier. The offer forecast is also multiplied by the target conversion rate of the candidate tier to get the target number of written policies in the planning horizon for the candidate tier.

Each pricing tier represents a different profitability level based on the degree to which the base rates exceed variable cost. There is a great deal of flexibility in the configuration of the rate optimization process. It can be configured to optimize the base profit, overall profit, or gross revenue generation. Rate optimization can use either a multiplicative or additive relationship to between rate and variable cost to define profit. The objective of rate optimization in all cases is to select the pricing tier that generates the greatest profit for the planning horizon, given an offer forecast and an expected conversion rate for each tier.

In a typical configuration base profit is optimized. Base profit is computed as the difference between base rate and variable cost. Variable costs are represented in a number of different ways in the insurance industry. Typically quantities such as pure premium, loss ratio, and combined ratio are used to refer to costs that must be accounted for in the ratemaking process. Any of these variables may be used and must be derived for each coverage type by ad hoc analysis external to the rate analytics process. First, base profit for the current tier is multiplied by the expected number of policies. This gives total expected base profit over the planning horizon. Next, base profit for the candidate tier is multiplied by the target written policies to get total target base profit for the candidate tier. If the target base profit exceeds the expected base profit of the current tier a rate change is recommended (S24, S44).

For example:

| | |
|---|---|
| Current tier base rate | $120 |
| Variable cost | $100 |
| Base profit | $20 |
| Expected offers | 1,000 |
| Conversion rate | 6% |
| Expected Base Profit | = $20 * 0.06 * 1,000 |
| | = $1,200 |
| Candidate tier base rate | $140 |
| Variable cost | $100 |
| Base profit | $40 |
| Expected Offers | 1,000 |
| Conversion rate | 4% |
| Target Base Profit | = $40 * 0.04 * 1,000 |
| | = $1,600 |

In this example, a recommendation to change the rate will be sent to the decision support system (S26) for analyst review.

For overall profit optimization, average rate levels are defined for each tier by ad hoc analysis external to the rate analytics process. Overall profitability for the tier is defined by the difference between the average rate level and average variable cost. The comparison of profitability between current and candidate tiers is the same as described above for base profit optimization. If gross revenue generation is the desired optimization objective, variable cost is set to zero.

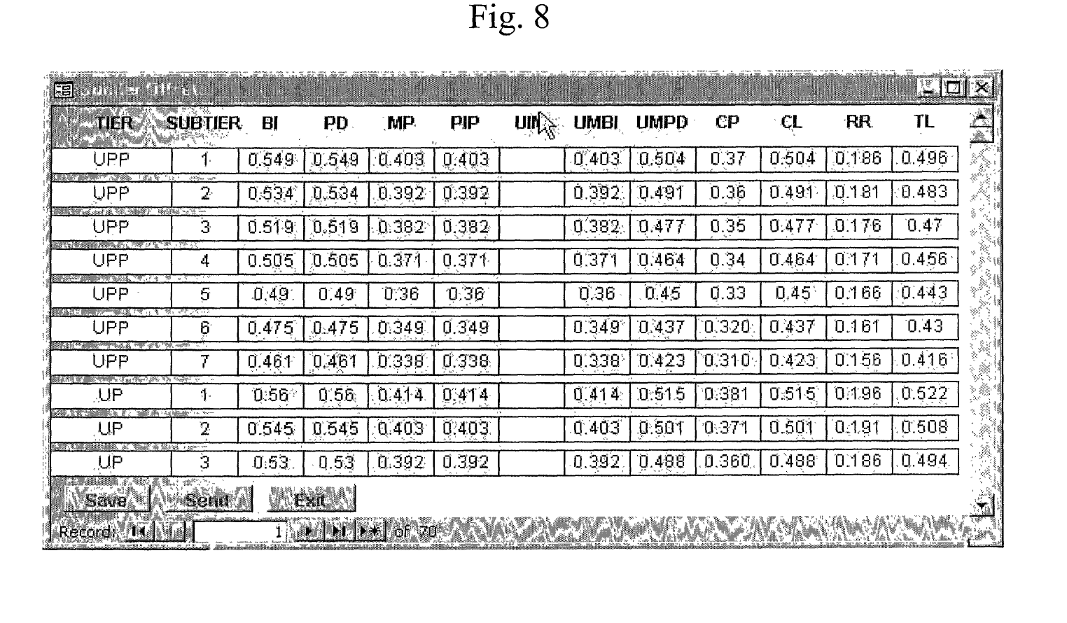

In some instances, the pricing analyst may want the rate optimization process to reflect compounding market effects such as adverse selection that would make a tier less profitable than it would seem from a consideration of the simple difference of base rate and variable cost. A multiplicative adverse selection factor, sensitive to the conversion rate forecast, may be applied to the tier base rate or average rate. The variable cost can be specified as a multiplicative factor proportional to the current base rate rather than a flat value. This supports the more traditional insurance pricing paradigm of using combined ratio as a revenue target. These are all implementation details configurable by the pricing analyst. FIG. 8, for example illustrates an adjustment factor applied to the base rate to get an adjusted base rate for a pricing tier.

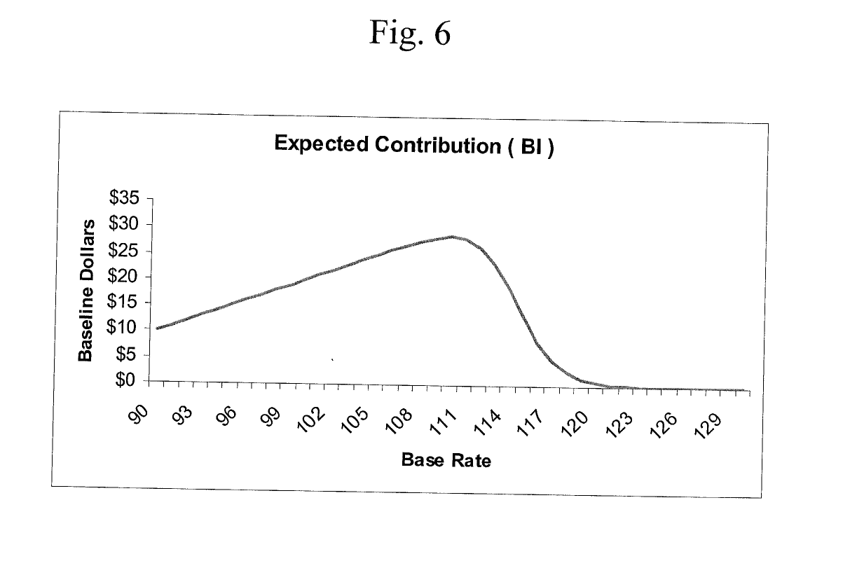

An exemplary relationship between profitability, rate, and demand is illustrated in FIG. 6. By consistent small steps in the direction of profitability the rate analytic process settles at optimal profit levels in stable markets and actively tracks the best price points in volatile markets.

In some implementations, identification of a segment as critical will cause the demand response curves corresponding to these market segments to be updated (S30). In other implementations the demand response cure is updated when the pricing analyst explicitly initiates the update procedure. A DRC (i.e. demand response curve) describes the percentage change in demand that is expected to occur in response to a percentage change in base rate. For each pricing variable the rate analytics process maintains a demand response curve. The DRC is initialized by one of a number of techniques including expert opinion, regression analysis on historic data, or simulation depending on the availability of information.

For example, a DRC for a dynamic ratemaking environment with three rate tiers could have three values. Suppose the variable of concern is pointed at rate tier number two:

| Rate Tier | Rate Difference | % Demand Change |
|---|---|---|
| 1 | 5% | −10% |
| 2 | 0% | 0% |
| 3 | −5% | 10% |
| 1 | 5% | −20% |
| 2 | 0% | 0% |
| 3 | −5% | 20% |

What this says is that we can stimulate an extra 10% demand if we cut the rate by 5%, or we could take an extra 5% premium per policy if we are willing to loose 10% of the demand.

As part of the analytic process, the actual demand that was realized for a particular rate segment is reviewed. If a different amount of demand than expected, expectations need to be revised. Suppose 90 policies are expected to be written in the previous month but instead 100 were written. A 10% demand increase that the current demand curve indicates is available is realized, but without a rate cut. Therefore, the following table is considered more accurate:

| Rate Tier | Rate Difference | % Demand Change |
|---|---|---|
| 1 | 5% | −20% |
| 2 | 0% | 0% |
| 3 | −5% | 20% |

In reality, the new results are incorporated so that they are taken into account, but do not dramatically change the table values for each observation. A smoothed table may look more like this:

| Rate Tier | Rate Difference | % Demand Change |
|---|---|---|
| 1 | 5% | −11% |
| 2 | 0% | 0% |
| 3 | −5% | 11% |

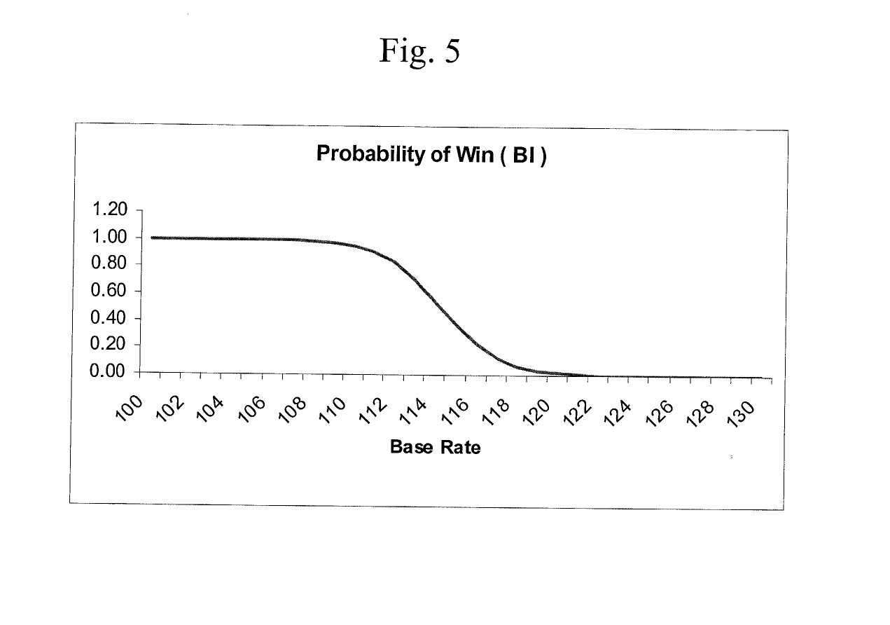

In certain embodiments, a binomial logit model is used to calculate the probability of an offer being accepted based on the price tier to which the offer belongs. Since the price tier corresponds to a particular value for the base rates, the logit model provides acceptance probabilities for various base rate levels. FIG. 5 illustrates an example of a relationship between the probability of acceptance for various base rate levels. Once the acceptance probability has been computed for each critical market segment, it is applied to the demand forecast to get an expected demand level for each price tier. The price tier that generates the greatest profit is identified as the optimal price tier.

The binomial logit model looks like this:

P(acceptance)=1/(1+exp(−(α+ΣβᵢXᵢ)))

Where

Xᵢ is a set of attributes of the offer that are believed to influence acceptance, in particular price tier membership and competitive position.

βᵢ is a set of coefficients computed by an iterative solver so that the likelihood that the equation accurately reflects the experience derived from a collection of historic offers is maximized

α is a coefficient that represents the component of the acceptance probability that is not sensitive to the attributes represented by the Xᵢ variables

A collection of accepted and rejected offers of insurance are derived historic customer behavior. Each offer has a set of values for the Xᵢ variables. Each offer also has accepted or rejected status. An iterative algorithm tries out various values of coefficients until it finds a set of values that make the binomial logit model most likely to return a correct probability of acceptance for all of the historic offers. Derivation of these coefficients is called logistic regression. This is similar to a linear regression algorithm with a number of important differences. Logistic regression derives coefficients for a functional form that looks like an S curve rather than a straight line. Logistic regression uses a maximum likelihood objective rather than ordinary least squares objective to compute coefficients. Logistic regression more accurately estimates dichotomous variables, such as accept/reject as compared to linear regression that provides estimates for continuous variables.

Alternatively, user defined demand response curves can be used. The rate management process allows the pricing analyst to specify a demand response curve and assign it to a market segment or a collection of market segments. The pricing analyst may also develop business rules that specify the curve. For example the pricing analyst may want the average to stay below the high rated competition 90% of the time but be above low rated competition 85% of the time for the middle rate tier. The demand curve generator uses the most recent competitive information it has to create a demand response curve that is constrained by these parameters. The finest level of detail for which a demand response curve is constructed is specific to a market segment. A market segment is defined by specific values for underwriting tier, coverage type, and each active pricing variable. Each market segment is associated with a demand response curve. However each demand response curve may not be constructed based on market segment specific information alone, because certain market segments will have inadequate amounts of demand to support construction of an accurate demand response curve. In these cases, the market segments are associated with a demand response curve from a more aggregate level of detail. The levels of detail for demand response curves are as follows:

| | |
|---|---|
| Level 1 | Underwriting Tier only |
| Level 2 | Underwriting Tier, Coverage Category |
| Level 3 | Underwriting Tier, Coverage Category, Single Pricing Variable |
| Level 4 | Underwriting Tier, Coverage Category, All Active Pricing |
| | Variables |
| Level 5 | Underwriting Tier, Coverage Type, All Active Pricing Variables |

The DRC associated with a market segment is the DRC with the finest level of detail that matches the definition of the market segment. For example a market segment defined by the following variables:

| Underwriting Tier | A | |
|---|---|---|
| Coverage | Bodily Injury | (Coverage Category = Liability) |
| Pricing Variable 1 | Y | (Binary Y/N, e.g. Homeowner) |
| Pricing Variable 2 | 23 | (Continuous, e.g. Age) |

A curve at the 5^{th} level of aggregation may not be determined because an insufficient number of 23 year olds have purchased insurance in the past, so that a DRC is not accurate at this level. Therefore, a match at level 3 may be needed, where the DRC is derived from data with the following attributes.

| | |
|---|---|
| Underwriting Tier | A |
| Coverage Category | Liability |
| Pricing Variable 1 | Y |

Rate management is the business process that delivers adjusted rates to the customer contact point. There are two primary approaches to rate management: operational rate management and automated rate management. In the operational environment, rate recommendations produced by the rate analytics process are reviewed by the pricing analyst. Operational rate management is supported by a decision support system that presents rate recommendations and related information in a concise manner. A communications component of the rate management system handles delivery of the reviewed rates to the customer contact points.

Automated rate management implements a control system approach that adjusts rate at the customer contact point without human intervention. Automated rate management also requires a decision support environment. The principal difference between the decision support environment for automated rate management and operational rate management is that the automated rate management tool is used to review recommended changes to the parameters of the pricing control system instead of explicit rates as in the case of operational rate management.

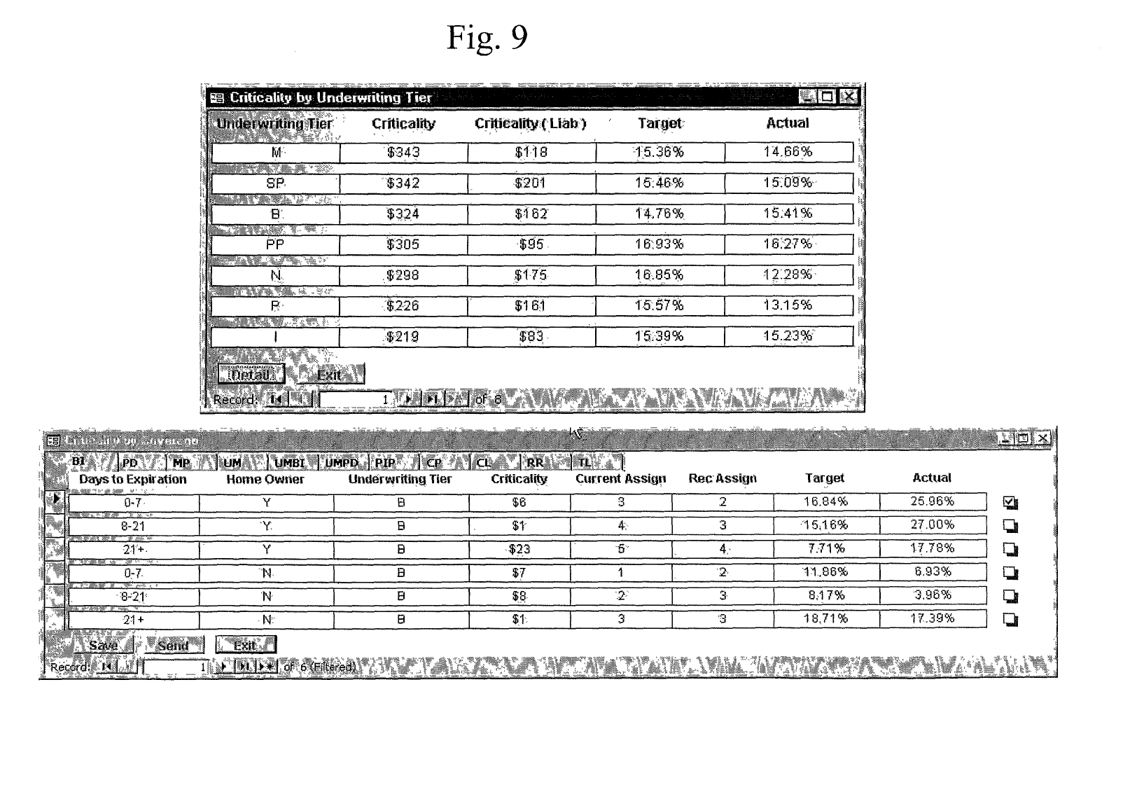

A dynamic ratemaking decision support system provides tools to evaluate rate or parameter recommendations from the analytic process and make rate adjustments either explicitly or by making changes to the pricing tier assignment. An exemplary decision support system, illustrated in FIG. 9, consists of the following components: workflow management tools, recommendations management tools, competitor monitoring and analysis tools, reports, and system administration tools.

Workflow management tools provide summary level information about customer behavior such as demand or conversion rate and rate and parameter recommendations. This information is presented at a level of aggregation that allows the most effective selection of which market segments to manage first.

Recommendations management tools permit detail viewing, editing and implementation or rejection of individual pricing actions. The most recent information of current and recommended rates and parameters is presented to the user. Management of communication with the customer contact point is also contained within the recommendation management tools.

Competitor monitoring tools provide timely competitor rate information in a concise manner. Competitor analysis tools evaluate pricing strategies in terms of competitor rate positions.

A variety of precompiled and user-definable reports are provided by the decision support system to support all aspects of rate management activity.

System administration and file maintenance tools permit authorized users to manually edit data and parameters in the decision support system.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of dynamically determining a pricing rate for an insurance product, comprising:
(a) grouping demand for any of a plurality of products together into any of a plurality of market segments based on at least one of a plurality of pricing variables;
(b) analyzing demand behavior of each market segment for consumer price sensitivity;
(c) establishing a price associated with each analyzed market segment;
(d) generating forecasts of demand for each analyzed market segment; and
(e) optimizing a pricing rate of a specific product based on said generated forecasts of demand.

2. The method of claim 1, further comprising periodically repeating steps (a)-(e).

3. The method according to claim 1, wherein the pricing variables include rating variables and other behavior variables.

4. The method according to claim 1, wherein analyzing demand behavior includes generating a unique forecast of demand for each of the plurality of market segments, the unique forecast of demand based on historical demand consisting of a mean and higher moments of a demand surrogate for each of the plurality of market segments.

5. The method according to claim 4, further comprising testing the unique forecast of demand against actual observed demand.

6. The method according to claim 5, further comprising determining a difference between the unique forecast of demand and the actual observed demand, and if the difference is of statistical significance, identifying the market segment associated with the unique forecast of demand as a critical segment.

7. The method according to claim 6, wherein establishing a price associated with each analyzed market segment includes assigning each analyzed market segment to a price tier.

8. The method according to claim 7, wherein assigning each market segment to a price tier includes assigning said critical market segment to a candidate price tier, the candidate price tier associated with an increase in price compared to a previous price tier if the unique forecast of demand is larger than the actual observed demand and associated with a decrease in price compared to the previous price tier if the unique forecast of demand is smaller than the actual observed demand.

9. The method according to claim 1, wherein establishing a price associated with each analyzed market segment includes assigning each analyzed market segment to a price tier.

10. The method according to claim 1, wherein the generated forecasts of demand are used to predict a number of conversions of a price tier assigned to each of the analyzed markets.

11. The method according to claim 1, wherein optimizing a pricing rate includes:
determining a percentage change in consumer demand that is expected to occur in response to a percentage change in a rate of a price tier containing said analyzed market segment; and
implementing a change in the rate of a price tier based upon said determined percentage change in consumer demand such that a profit from said pricing tier is maximized.

12. A method of dynamically determining a pricing rate for an insurance product, comprising:
grouping demand for any of a plurality of products together into any of a plurality of market segments based on a group of pricing variables, wherein the pricing variables include rating variables and other behavior variables;
assigning each market segment to a price tier;
generating a unique forecast of demand for each market segment, including testing the unique forecast of demand against actual observed demand, and determining a difference between the unique forecast of demand and the actual observed demand, and if the difference is of statistical significance, identifying the market segment associated with the unique forecast of demand as a critical segment, wherein the unique forecast of demand is based on historical demand consisting of a mean and higher moments of a demand surrogate for each of the plurality of market segments; and
adjusting the price tier of the market segment according to the difference, if the difference is of statistical significance.

13. A method of determining an optimized price for offering an insurance product to a customer, comprising:
analyzing attributes of a customer's demand behavior;
assigning the customer to one of a plurality of price tiers based upon the attributes of the customer's demand behavior;
forecasting whether the customer will accept an offer to purchase the product based on the assigned price tier; and
generating an optimized price based on the forecast.

14. The method of claim 13, further comprising:
compiling the attributes of a plurality of customers; and
adjusting rates associated with the plurality of price tiers based on the compiled attributes.

15. The method of claim 13, wherein price tier assignments are generated based on a price tier assignment database.

16. The method of claim 13, wherein the customer is assigned to a price tier based on the attributes and on a plurality of customer characteristics.

17. The method of claim 13, wherein generating of an optimized price is based on forecasted acceptance rates and assigning a price tier that implements the optimized price.

18. A method of dynamically setting pricing rates for an insurance product comprising:
compiling data associated with historical demand behavior of a plurality of customers for the product;
developing a plurality of market segments based on the data associated with historical demand behavior, wherein each market segment has common attributes;
analyzing attributes of a particular customer and assigning the customer to a market segment having common attributes;
evaluating customer characteristics of the particular customer;
assigning the customer to a pricing tier based on the assigned market segment and the customer characteristics; and
providing a pricing rate for the particular customer based on the pricing tier.

19. The method of claim 18, further comprising:
including data associated with the particular customer in the data associated with the historical behavior of a plurality of customers for the product to provide new compiled data; and adjusting the market segments based on the new compiled data.
